(19) United States
(12) Patent Application Publication
(10) Pub. No.: US 2022/0275136 A1
(43) Pub. Date: Sep. 1, 2022

(54) PROCESS FOR POLYMERIZING A COMPOSITION IN THE PRESENCE OF A BLOCK COPOLYMER

(71) Applicants: Arkema France, Colombes (FR); Centre National De La Recherche Scientifique - CNRS, Paris (FR); UNIVERSITE DE PAU ET DES PAYS DE L'ADOUR, Pau Cedex (FR)

(72) Inventors: Sylvain Bourrigaud, LACQ (FR); Anne-Laure Brocas, LACQ (FR); Sylvie Cazaumayou, LACQ (FR); Laura Garcia Andujar, Pau (FR); Maud Save, Escala (FR); Christophe Derail, Cescau (FR); Laurent Rubatat, Pau (FR)

(73) Assignees: Arkema France, Colombes (FR); Centre National De La Recherche Scientifique - CNRS, Paris (FR); UNIVERSITE DE PAU ET DES PAYS DE L'ADOUR, Pau Cedex (FR)

(21) Appl. No.: 17/612,839

(22) PCT Filed: May 19, 2020
(86) PCT No.: PCT/FR2020/050827

§ 371 Date: Nov. 19, 2021

(30) Foreign Application Priority Data
May 24, 2019 (FR) FR1905519

(51) Int. Cl. C08F 287/00

(52) U.S. Cl. CPC C08F 287/00

(57) ABSTRACT

The present invention relates to a process for the polymerization of a composition in the presence of at least one block copolymer, and also to the products obtained by this polymerization process. The present invention also relates to the use of the products obtained using the polymerization process which is a subject matter of the invention.

### CROSS-REFERENCE TO RELATED APPLICATIONS

This application is the national phase of International Application No. PCT/FR2020/050827, filed 19 May 2020, which claims priority to French Application No. FR 1905519, filed 24 May 2019, the disclosure of each of these applications being incorporated herein by reference in its entirety for all purposes.

### FIELD OF THE INVENTION

The present invention relates to a process for the polymerization of a composition in the presence of at least one block copolymer, and also to the products obtained by this polymerization process. The present invention also relates to the use of the products obtained using the polymerization process which is a subject matter of the invention.

### BACKGROUND OF THE INVENTION

Synthesis processes making it possible to obtain block copolymers are well known, whether they are radical, anionic, ring opening or polycondensation processes.

The block copolymers obtained by such processes exhibit particular properties linked to their morphologies resulting from the structuring in the form of nanodomains. The relationships between the type of nanodomains and the macroscopic properties of the material obtained, whether they are mechanical, optical, rheological, and the like, properties, are better understood today.

The structuring of block copolymers and the associated morphologies are predictable by phase diagrams. It is known, for example, to direct the type of nanostructure as a function of the chemical nature of the blocks, their molecular weight or also their number.

However, it is difficult to direct a combination of properties, for example of good mechanical properties and of good optical properties.

Thus, for example, on a lamellar morphology, it is known that large-sized lamellae are favorable to good mechanical properties but unfavorable to the optical properties due to the diffraction which results therefrom.

Conversely, the small sizes of lamellae are favorable to the optical properties to the detriment of the mechanical properties. In point of fact, the size of the lamellae is governed by the molecular weight of the block copolymer. The higher the molecular weight, the greater the dimensions of the lamellae, which is favorable to the mechanical properties but unfavorable to the optical properties, and vice versa. While the increase in the content of soft phase in a composition favorably influences the mechanical properties, a change in the morphology is observed with disappearance of the lamellar morphologies for higher contents of soft phase, penalizing the optical properties.

To date, it has not been possible to circumvent these obstacles other than by methods requiring additional stages and only in certain cases.

One of the novel features of the process is that of obtaining controllable lamellar morphologies for mass ratios of the blocks (overall soft/hard in the material) of 8.5/91.5 to 20/80, that is to say much lower than the conventional values between 40/60 and 60/40 obtained with block copolymers or mixtures of copolymers and of homopolymers at thermodynamic equilibrium. This results in lamellae which are very asymmetric in thickness, that is to say an alternation of thin and thick lamellae of different nature. It is thus possible to master the asymmetry by the addition of preformed block copolymers. Another advantage and novel feature of the process is the implementation, cast sheet type, exhibiting limited viscosities of the initial formulations. The term “soft” is associated with a block having a Tg of less than 0° C. The term “hard” is associated with a block having a Tg of greater than 20° C.

The applicant company has discovered that it is possible to control the morphology and the size of the (preferably lamellar) morphology of a block copolymer induced by bulk polymerization of a composition, whatever their molecular weight.

This is made possible by adding, during the synthesis process, one or more other block copolymers (several block copolymers of natures and structures), which can be of identical or different nature(s), in the composition of the blocks.

### SUMMARY OF THE INVENTION

The invention relates to a process for the (bulk) polymerization of a composition, said composition comprising at least one macroinitiator, at least one block copolymer and at least one monomer (said monomer being wholly or partly different from the monomer(s) present in the macroinitiator), comprising the following stages:
mixing of at least one macroinitiator and of at least one block copolymer in a solution comprising at least one liquid monomer,
polymerization of this solution,
recovery of the solid composed of a mixture of copolymers.

### BRIEF DESCRIPTION OF THE DRAWINGS

FIG. 1 is a surface topography image of control Sample 1 prepared without the presence of block copolymer.

FIG. 2 is a surface topography image of control Sample 2 prepared without the presence of block copolymer.

FIG. 3 is a surface topography image of Sample 3 prepared in the presence of 2.5% by weight of block copolymer.

FIG. 4 is a surface topography image of Sample 4 prepared in the presence of 5% by weight of block copolymer.

FIG. 5 is a surface topography image of Sample 5 prepared in the presence of 10% by weight of block copolymer.

FIG. 6 is a surface topography image of Sample 6 prepared in the presence of 16% by weight of block copolymer.

FIG. 7 is a surface topography image of Sample 7 prepared in the presence of 30% by weight of block copolymer.

FIG. 8 shows preservation of the lamellar morphology with an interlamellae distance which decreases as the proportion of block copolymer increases.

FIG. 9 is a surface topography image of Sample 8 where the type of block copolymer resulted in a polygonal morphology.

FIG. 10 is a surface topography image of Sample 9 where the type of block copolymer resulted in a lamellar morphology.

FIG. 11 is a surface topography image of Sample 10 where the type of block copolymer resulted in a lamellar morphology.

### DETAILED DESCRIPTION OF THE INVENTION

The term “bulk polymerization” is understood to mean the process carried out between glass sheets called “cast sheets” process, the suspension process, the process by reactive or nonreactive extrusion, and also any other process involving a container containing the constituents of the composition to be polymerized.

The polymerization can be carried out in an anionic manner, by polycondensation or in a radical manner, with thermal or photochemical initiation. Preferably, the polymerization is carried out in a radical manner.

The term “macroinitiator” is understood to mean an oligomer or a polymer, the weight-average molecular weight of which is between 5000 and 350 000 g/mol, preferably between 25 000 and 250 000 g/mol, carrying at least one functional group capable of initiating a radical polymerization controlled by RAFT, ATRP, NMP, RITP or Cu(0) and preferably by NMP (nitroxide-mediated polymerization).

The term “controlled radical polymerization” is also understood to mean the expression “reversible-deactivation radical polymerization” as defined by the IUPAC.

The macroinitiator, the monomers and also the constituent monomers of the block copolymer(s) used in the process of the invention are formed of the monomers chosen from the following list:

Monomers of vinyl, vinylidene, diene, olefinic, allyl or (meth)acrylic type and more particularly vinylaromatic monomers, such as styrene or substituted styrenes, in particular α-methylstyrene or silylated styrenes, acrylic monomers, such as acrylic acid or its salts, alkyl, cycloalkyl or aryl acrylates, such as methyl, ethyl, butyl, ethylhexyl or phenyl acrylate, hydroxyalkyl acrylates, such as 2-hydroxyethyl acrylate, ether alkyl acrylates, such as 2-methoxyethyl acrylate, alkoxy- or aryloxypolyalkylene glycol acrylates, such as methoxypolyethylene glycol acrylates, ethoxypolyethylene glycol acrylates, methoxypolypropylene glycol acrylates, methoxypolyethylene glycol-polypropylene glycol acrylates or their mixtures, aminoalkyl acrylates, such as 2-(dimethylamino)ethyl acrylate (DAMEA), fluoroacrylates, isobornyl acrylate, 4-(tert-butyl)cyclohexyl acrylate, silylated acrylates, phosphorus-comprising acrylates, such as alkylene glycol phosphate acrylates, glycidyl or dicyclopentenyloxyethyl acrylates, methacrylic monomers, such as methacrylic acid or its salts, alkyl, cycloalkyl, alkenyl or aryl methacrylates, such as methyl methacrylate (MMA) or lauryl, cyclohexyl, allyl, phenyl or naphthyl methacrylate, hydroxyalkyl methacrylates, such as 2-hydroxyethyl methacrylate or 2-hydroxypropyl methacrylate, ether alkyl methacrylates, such as 2-ethoxyethyl methacrylate, alkoxy- or aryloxypolyalkylene glycol methacrylates, such as methoxypolyethylene glycol methacrylates, ethoxypolyethylene glycol methacrylates, methoxypolypropylene glycol methacrylates, methoxypolyethylene glycol-polypropylene glycol methacrylates or their mixtures, aminoalkyl methacrylates, such as 2-(dimethylamino)ethyl methacrylate (DAMEMA), fluoromethacrylates, such as 2,2,2-trifluoroethyl methacrylate, silylated methacrylates, such as 3-methacryloyloxypropyltrimethylsilane, phosphorus-comprising methacrylates, such as alkylene glycol phosphate methacrylates, hydroxyethylimidazolidone methacrylate, hydroxyethylimidazolidinone methacrylate, 2-(2-oxo-1-imidazolidinyl)ethyl methacrylate, acrylonitrile, acrylamide or substituted acrylamides, 4-acryloylmorpholine, N-methylolacrylamide, methacrylamide or substituted methacrylamides, N-methylolmethacrylamide, methacrylamidopropyltrimethylammonium chloride (MAPTAC), glycidyl or dicyclopentenyloxyethyl methacrylates, itaconic acid, maleic acid or its salts, maleic anhydride, alkyl or alkoxy- or aryloxypolyalkylene glycol maleates or hemimaleates, vinylpyridine, vinylpyrrolidinone, (alkoxy)poly(alkylene glycol) vinyl ether or divinyl ether, such as methoxypoly(ethylene glycol) vinyl ether or poly(ethylene glycol) divinyl ether, olefinic monomers, among which may be mentioned ethylene, butene, hexene and 1-octene, diene monomers, including butadiene or isoprene, and also fluoroolefinic monomers, and vinylidene monomers, among which may be mentioned vinylidene fluoride, alone or as a mixture of at least two abovementioned monomers.

Preferably, they are alkyl acrylates and methacrylates, isobornyl acrylate and methacrylate, 4-(tert-butyl)cyclohexyl acrylate and/or substituted or unsubstituted styrene, and preferably butyl acrylate, isobornyl acrylate and methacrylate, 4-(tert-butyl)cyclohexyl acrylate, methyl methacrylate and styrene.

The macroinitiator (or the macroinitiators) can be monofunctional or multifunctional. Preferably, it is multifunctional. It can be represented in the following way when radical polymerization is concerned:

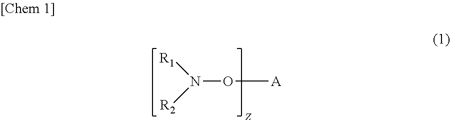

A is a hydrocarbon group with or without heteroatom which can contain at least one metal entity, and is of polymeric or oligomeric nature,
R₁ is a hydrocarbon group with or without heteroatom which can contain at least one metal entity,
R₂ is a hydrocarbon group with or without heteroatom which can contain at least one metal entity,
Z is an integer between 1 and 10, limits included, preferably from 2 to 4, limits included, and more preferably from 2 to 3, limits included.

It is prepared using alkoxyamines of any type and the abovementioned monomers, but preferably with the following alkoxyamines:

As regards the monoalkoxyamines used for the synthesis of the macroinitiator(s), use may be made of any type of monoalkoxyamine in the context of the invention; however, preference will be given to the monoalkoxyamines of following formula:

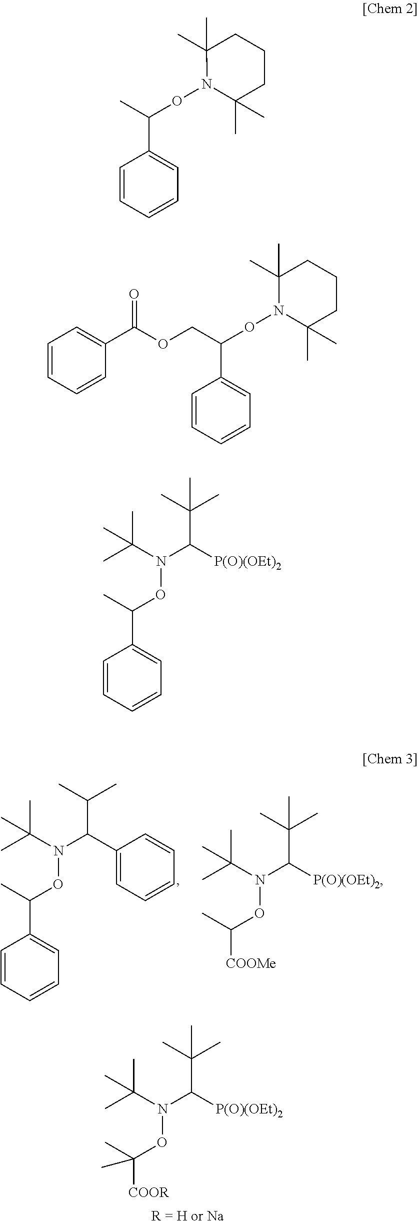

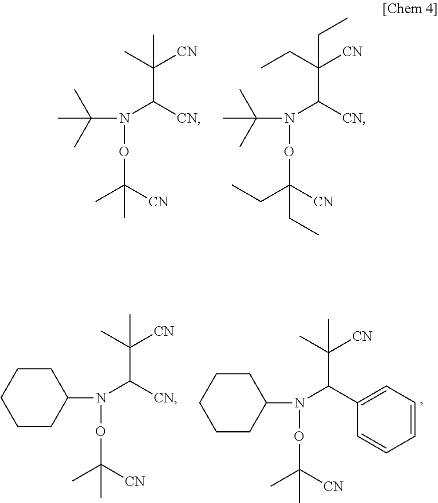

More particularly, the following monoalkoxyamine will be chosen:

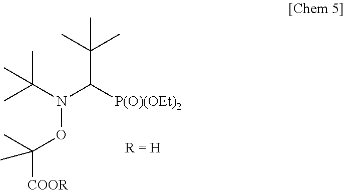

As regards the dialkoxyamines used for the synthesis of the macroinitiator(s), use may be made of any type of dialkoxyamine in the context of the invention; however, preference will be given to the dialkoxyamines of following formula:

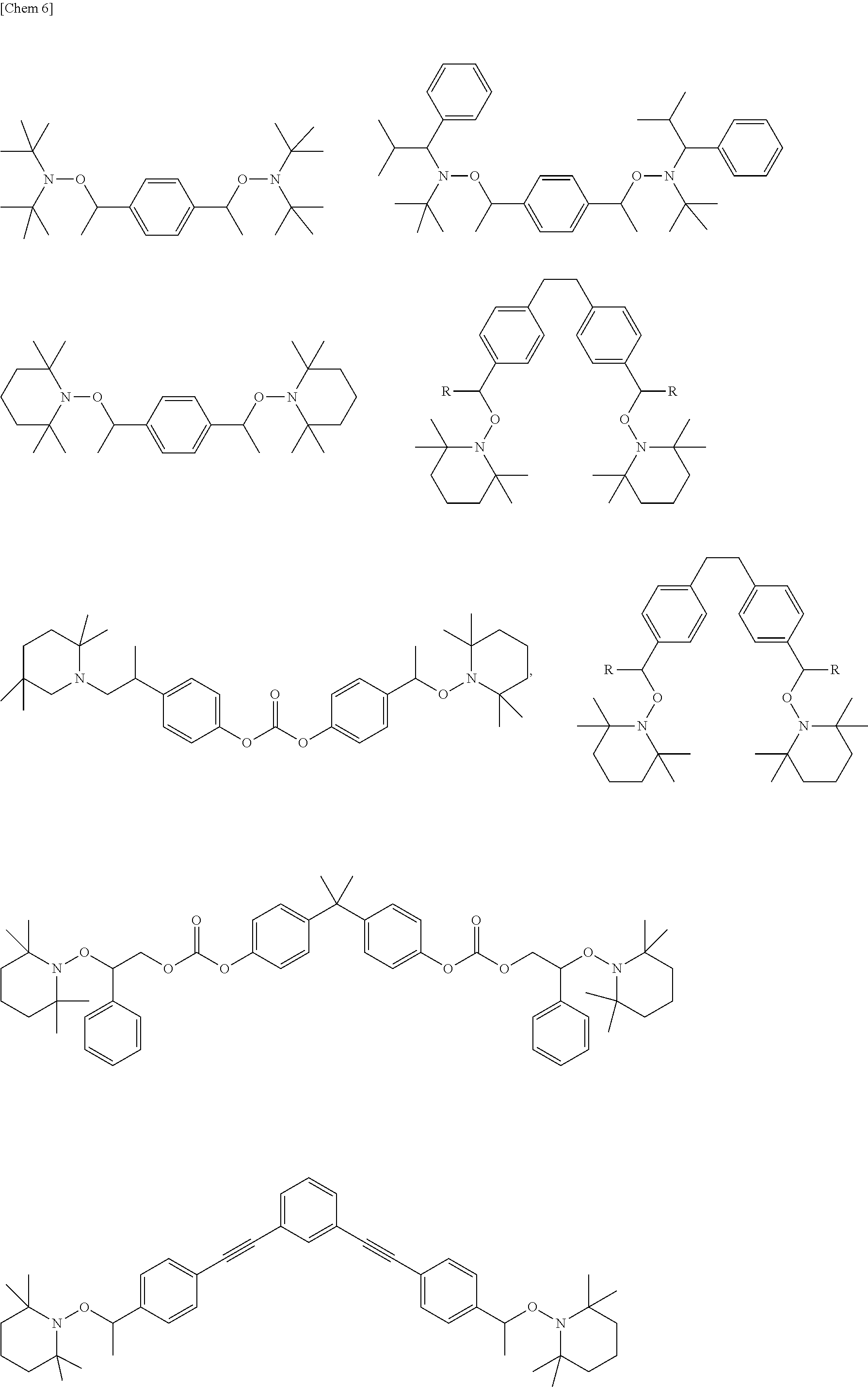

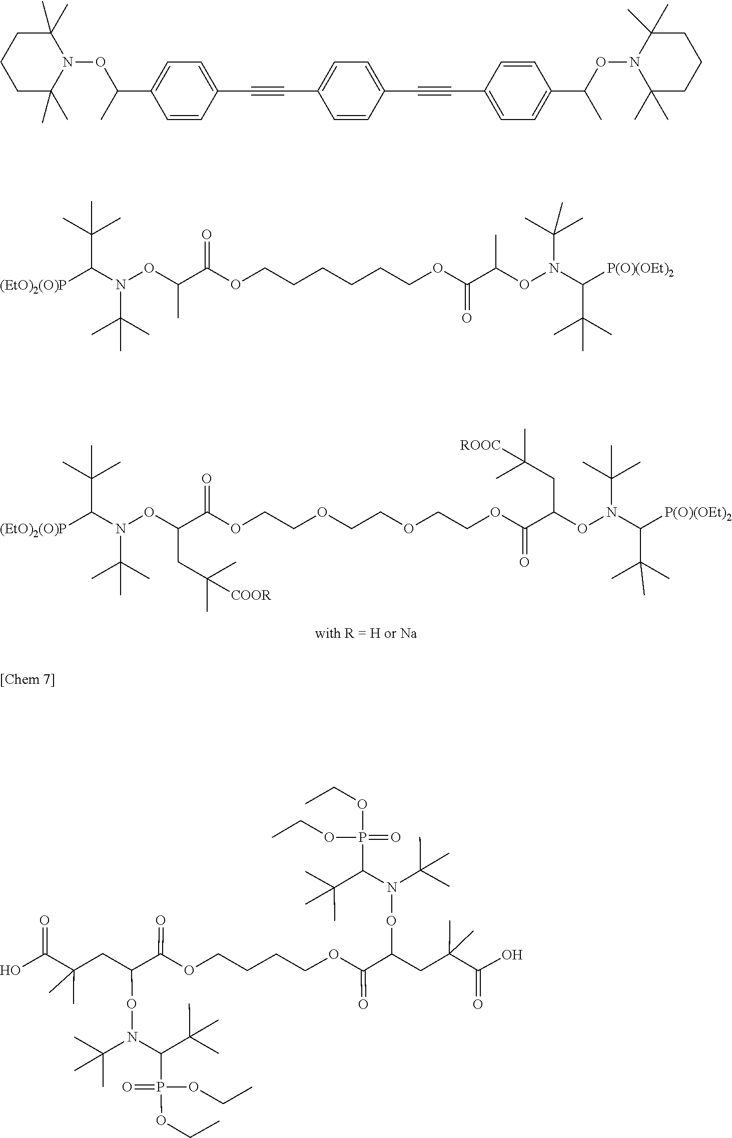

More particularly, the following structures will be preferred:

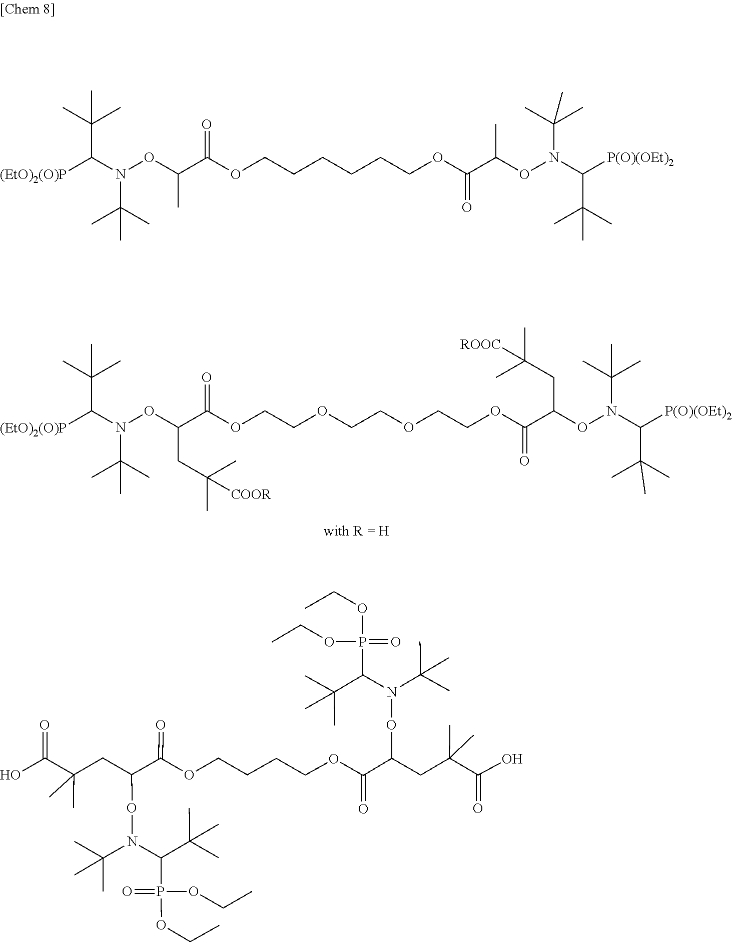

More preferably, the following dialkoxyamine will be chosen:

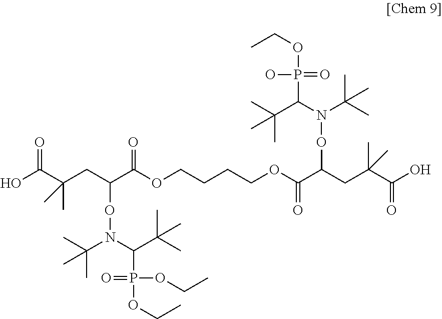

It can be prepared by addition of N-(2-methylpropyl)-N-(1-diethylphosphono-2,2-dimethylpropyl)-O-(2-carboxyprop-2-yl)hydroxylamine to butanediol diacrylate.

As regards the trialkoxyamines used for the synthesis of the macroinitiator(s), use may be made of any type of trialkoxyamine in the context of the invention; however, preference will be given to the trialkoxyamine of following formula, the product of the addition of N-(2-methylpropyl)-N-(1-diethylphosphono-2,2-dimethylpropyl)-O-(2-carboxyprop-2-yl)hydroxylamine to pentaerythritol triacrylate:

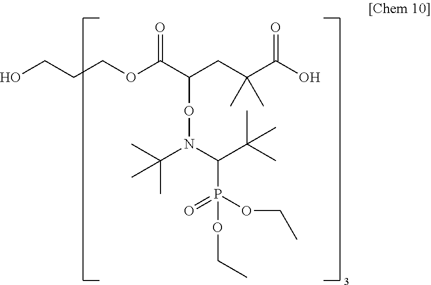

The block copolymer(s) used in the process of the invention can be linear or star-branched multiblock copolymer(s). Preferably, the block copolymer used in the process of the invention is a diblock or triblock copolymer and preferably a triblock copolymer, and more preferably a linear triblock copolymer. The block copolymer(s) used in the process of the invention exhibits at least one block with a glass transition temperature Tg of less than 0° C. and preferably of less than −10° C. and more preferably of less than −30° C. and at least one block with a glass transition temperature Tg of greater than 20° C. and preferably of greater than 30° C. The block copolymer(s) used in the process of the invention is present in amounts by weight of between 0% and 90%, 0% excluded, and preferably between 2.5% and 30% by weight.

The morphologies of the copolymers obtained using the process of the invention can be similar to the morphologies of any type allowed, or not, by the theoretical phase diagram (at thermodynamic equilibrium) of the linear and star-branched block copolymers; such as lamellar, spherical, cylindrical, gyroidal, polyhedral or polygonal and preferably lamellar morphologies.

The size of the domains and the morphology can be adjusted as a function of the block copolymer(s) used in combination with the characteristics of the macroinitiator(s).

Thus, it is possible to direct the morphology and the size of the domains as a function of the molecular weights of the block copolymer(s) and their amount, molecular weights of each of the blocks, nature of the blocks and also their number and/or of the molecular weight of the macroinitiator(s), functionality and/or type of monomers.

The invention also relates to the polymers obtained using the process of the invention. These polymers resulting from the process of the invention can be provided directly in the form of an object. These are, for example, sheets obtained by the “cast sheets” process. The invention thus also relates to these objects, and particularly to these cast sheets, whatever their thicknesses and their dimensions.

The invention also relates to the use of these cast sheets, in the fields of glazing in general, more particularly of urban and sports glazing, automobiles, motorcycles, ballistics, or also electronics.

The invention also relates to polymers and objects obtained by processes other than the cast sheets process, whether they are polymers and objects obtained, for example, by the suspension process (powders) or the extrusion process (granules or extruded rods, threads).

In the case of the suspension process, the powders obtained can be used in many fields, such as 3D printing by laser sintering, or additives making it possible to improve the mechanical properties and/or the processing properties of other polymers and in particular acrylic polymers or fluoropolymers. The invention thus also relates to the use of these powders in these two fields.

With regard to 3D printing, the process of the invention can also be used in stereolithography, the polymerization being activated with at least one photoinitiator.

In the case of the extrusion process, the granules or extruded rods, threads obtained can be used in many fields as additives making it possible to improve the mechanical properties and/or the processing properties of other polymers and in particular acrylic polymers or fluoropolymers, but also 3D printing (laser sintering or filament deposition). The invention thus also relates to the use of these powders in these two fields.

### EXAMPLES

### Example 1: Synthesis of Macroinitiators

The synthesis of the macroinitiators is carried out according to the protocol described in EP 1 526 138 in example 1, except that, in the present case, only butyl acrylate is used as monomer. The functional compound used in this example is 1,4-butanediol diacrylate, making possible the synthesis of a difunctional macroinitiator, but, in order to prepare macroinitiators of functionality >2, a person skilled in the art will be capable of choosing the appropriate functional compound (for example pentaerythritol triacrylate in order to obtain a macroinitiator of functionality 3).

### Example 2: Synthesis of Polymers

The synthesis of polymers is carried out by pouring the reaction mixture into a mold, followed by polymerization. The amounts indicated subsequently correspond to those necessary to obtain the sample 3, the data of which appear in table 1. The process is carried out in four stages. The first stage consists of the dissolution of 14.6 g of macroinitiator in 180.4 g of MMA (methyl methacrylate) with magnetic stirring for approximately 15 minutes in an Erlenmeyer flask. In the second stage, 5 g of preformed block copolymers are added to the macroinitiator/MMA mixture with magnetic stirring until complete dissolution of the preformed copolymers, that is to say 2 h. The third stage consists of the degassing of the reaction solution under nitrogen for 30 minutes. The fourth stage is the casting in a glass mold, with dimensions of 25 cm by 25 cm with a PVC seal of 4 mm in thickness; before transfer to an oven for polymerization. The polymerization cycle employed is as follows: a first temperature gradient from 25° C. to 75° C. in 50 min, followed by a second gradient up to 85° C. reached in 520 min. A final gradient up to 125° C. in 430 min, followed by a plateau of 60 min at this same temperature, make it possible to ensure complete polymerization of the MMA. The mold is subsequently opened in order to recover the sheet.

In the continuation of the text, the percentage by weight of total polybutyl acrylate in the final sample is considered as content of soft phase. This takes into account the amount of polybutyl acrylate contributed by the macroinitiator and also the amount contributed by the added preformed copolymer. The example below describes in detail the calculation for 100 g of the sample 3:

On the one hand:
Amount of preformed copolymer=2.5%, i.e. 2.5 g
Content of polybutyl acrylate (PnBA) in the preformed block copolymer=47%
Total amount of PnBA contributed by the copolymer=2.5×0.47=1.2 g

On the other hand:
Amount of macroinitiator/MMA solution=97.5%, i.e. 97.5 g
Content of PnBA in the macroinitiator/MMA solution=7.5%
Total amount of PnBA contributed by the macroinitiator/MMA solution=97.5×0.075=7.3 g

Total content of soft phase:
Total amount of PnBA in the final sample=1.2 g+7.3 g=8.5 g, i.e. 8.5% by weight.

### Example 3: Morphology

### Table 1: Samples Observed in AFM

Atomic Force Microscopy (AFM) tests have made possible the study of the surface structuring. In order to carry out these analyses, the samples were cut beforehand by ultramicrotomy at ambient temperature using a Leica EM UC7 ultramicrotome. The diamond knives used were a Diatome Diamond Knife Cryotrim 45 for the precut and a Diatome Diamond Knife Ultra 45 for the final cut. The AFM device used for producing the images is the Bruker MultiMode 8 Atomic Force Microscope in the PeakForce QNM (Quantitative NanoMechanics) mode with a silicon nitride tip having a nominal radius of curvature of 2 nm (ScanAssist-AIR). The images made use of and presented in the figures are surface topography images (height images) of 5 by 5 micrometers with a spatial resolution at acquisition of 512 by 512 pixels. The software used for the measurements and image processing operations is the Bruker NanoScope Analysis Version 1.5. The interlamellar dimensions presented in FIG. 8 are averages calculated over a minimum of 12 measurements; the error bars were calculated from the standard deviation.

The samples observed are summarized in table 1. The block copolymer introduced at the start, when present, is the sample C of table 2.

TABLE 1

| | Content by weight of block | Content by | | | | |
|---|---|---|---|---|---|---|
| | copolymer C introduced | weight of | | | | |
| Sample | before the synthesis | soft phase | Morphology | FIG. | | ¤ |
| 1¤ | 0¤ | 7.5¤ | Lamellar ¤ | 1¤ | ¤ | ¤ |
| 2¤ | 0¤ | 15¤ | Polygonal ¤ | 2¤ | ¤ | ¤ |
| 3¤ | 2.5¤ | 8.5¤ | Lamellar ¤ | 3¤ | ¤ | ¤ |
| 4¤ | 5¤ | 9.5¤ | Lamellar ¤ | 4¤ | ¤ | ¤ |
| 5¤ | 10¤ | 11.6¤ | Lamellar ¤ | 5¤ | ¤ | ¤ |
| 6¤ | 16¤ | 15¤ | Lamellar ¤ | 6¤ | ¤ | ¤ |
| 7¤ | 30¤ | 19.7¤ | Lamellar ¤ | 7¤ | ¤ | ¤ |

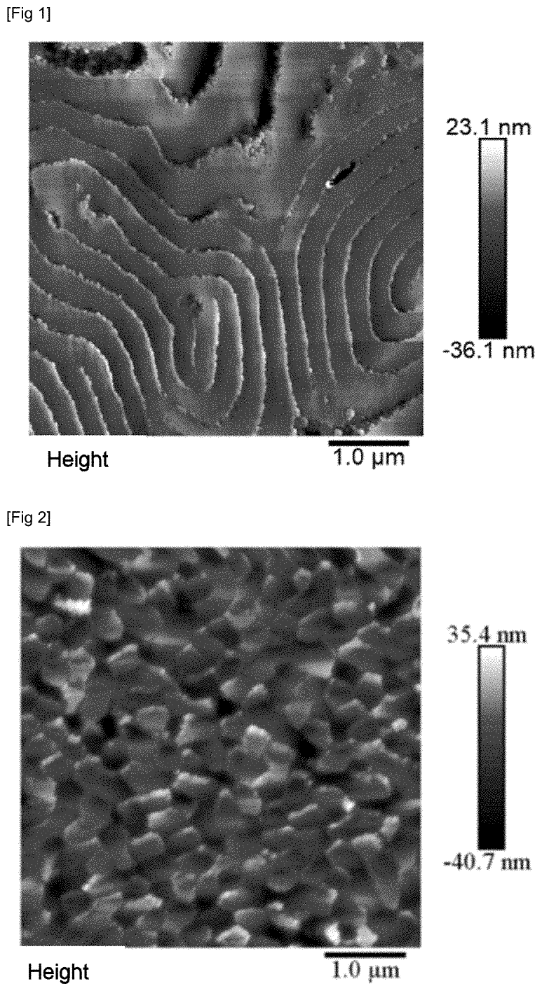

The control samples prepared without the presence of block copolymer were observed in AFM for two compositions respectively containing 7.5% and 15% by weight of soft phase (P(BuA-co-Sty) of the macroinitiator); FIGS. 1 and 2.

It is observed that the fact of moving from 7.5% to 15% of soft phase in the sample causes the morphology to change from lamellar to polygonal.

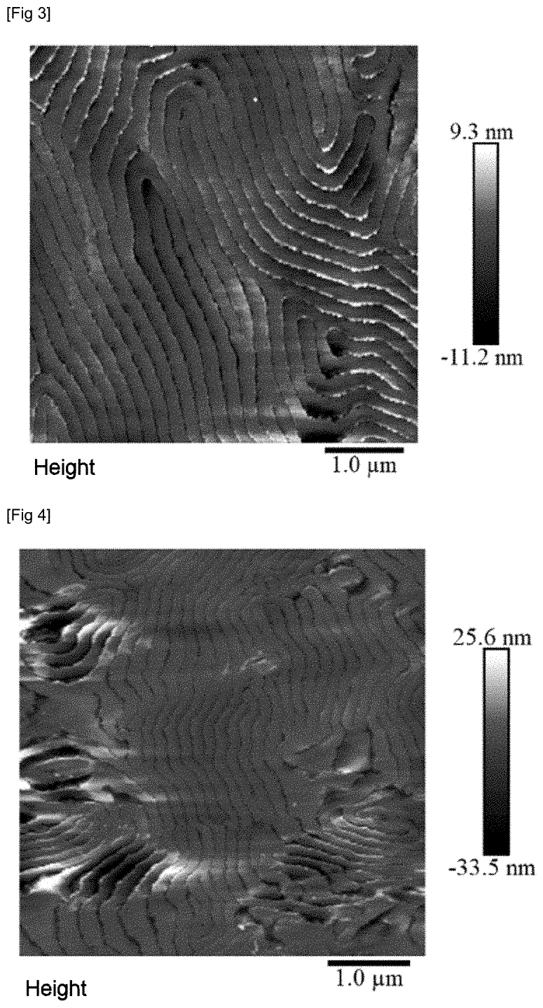

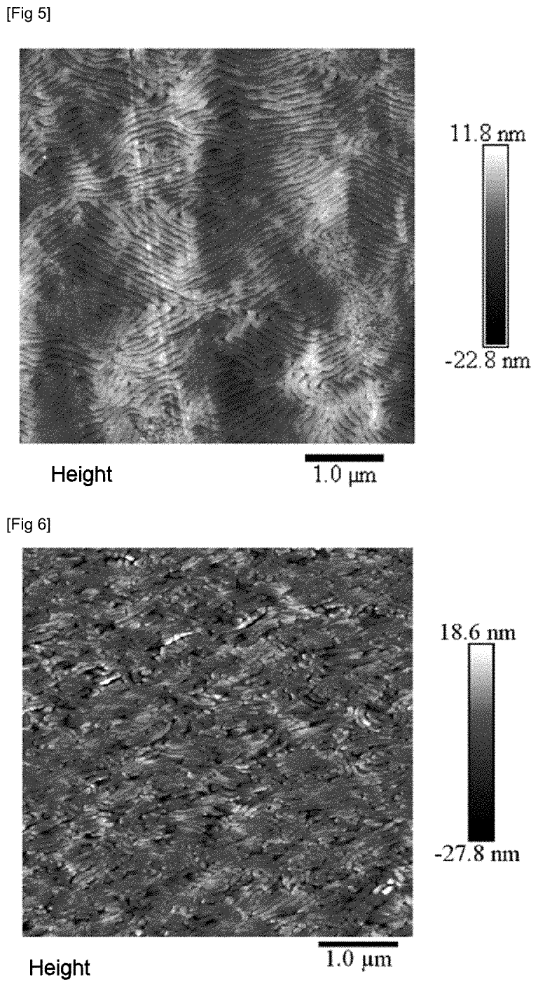

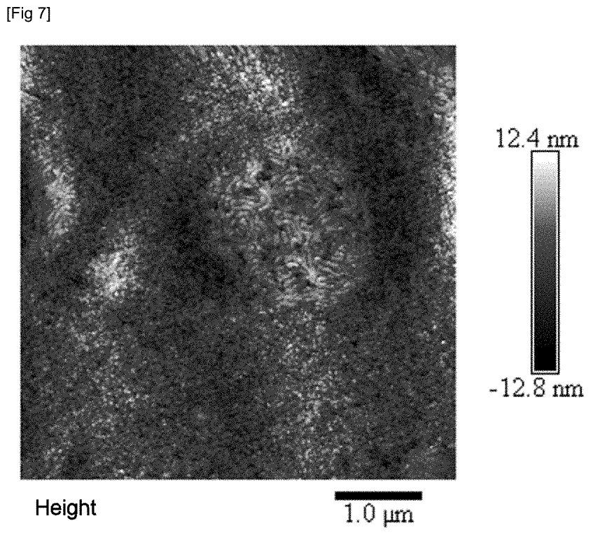

The samples which are subject matters of the invention prepared in the presence of respectively 2.5%, 5%, 10%, 16% and 30% by weight of block copolymer were observed in AFM; FIGS. 3, 4, 5, 6 and 7.

In all cases, preservation of the lamellar morphology is observed, even on the 30% sample prepared in the presence of 30% of block copolymer, this being the situation for a content of soft phase of 19.7%.

In the presence of block copolymer before the synthesis, preservation of the lamellar morphology is observed, with an interlamellae distance which decreases as the proportion of block copolymer increases. (FIG. 8).

With an increasing content of soft phase, the impact strength will increase as the content of soft phase increases, this being the case while reducing the size of the lamellae.

This thus constitutes a major advance because these products with a high content of soft phase will exhibit good mechanical properties and good optical properties (no light scattering, good transparency because of low interlamellar distance).

The influence of the type of block copolymer was studied. Star-branched and linear block copolymers were compared in identical proportions and for equivalent contents of soft phase of the sample. The properties of the various copolymers tested are summarized in table 2.

TABLE 2

| | | PnBA/ | | Mₙ |
|---|---|---|---|---|
| Sample | Structure | PMMA-Ratio | % Styrene | (g mol⁻¹) |
| C¤ | BAB¤ | 47/53¤ | 0¤ | 46•000¤ |
| CT1¤ | (AB)₃¤ | 50/50¤ | 7.0¤ | 258•200¤ |
| CT2¤ | (AB)_{3¤}¤ | 46/54¤ | 6.4¤ | 198•600¤ |
| MS50¤ | BAB¤ | 45/55¤ | 6.3¤ | 47•000¤ |

The molar masses were determined by size exclusion chromatography using the PS calibration.

The tests carried out with various preformed block copolymers are summarized in table 3.

TABLE 3

| | Content by weight | | | | | |
|---|---|---|---|---|---|---|
| | of block copolymer | Architecture of | Mₙ Block | Content of | | |
| | introduced before | the block | copolymer | soft phase | | |
| Sample ¤ | the synthesis | copolymer | (g.mol⁻¹) ¤ | of the sample ¤ | Morphology ¤ | Figure¤ |
| 8¤ | 2.44¤ | star-branched, | 258000¤ | 8.5¤ | Polygonal ¤ | 9¤ |
| | | 3 branches | | | | |
| 9¤ | 2.44¤ | star-branched, | 199000¤ | 8.5¤ | Lamellar ¤ | 10¤ |
| | | 3 branches | | | | |
| 10¤ | 2.44¤ | linear triblock ¤ | 47000¤ | 8.4¤ | Lamellar ¤ | 11¤ |

The molecular weights were measured by SEC, polystyrene samples.

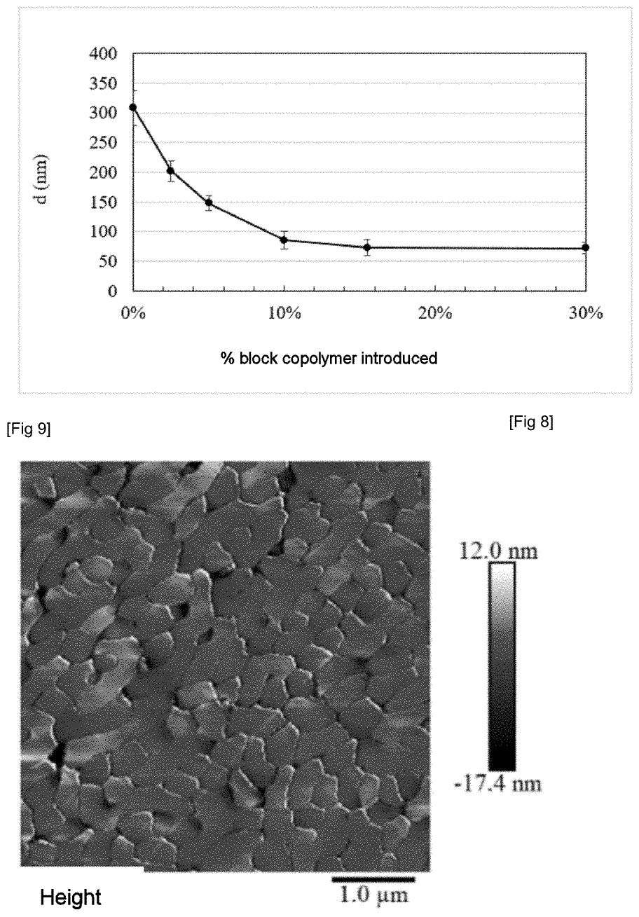

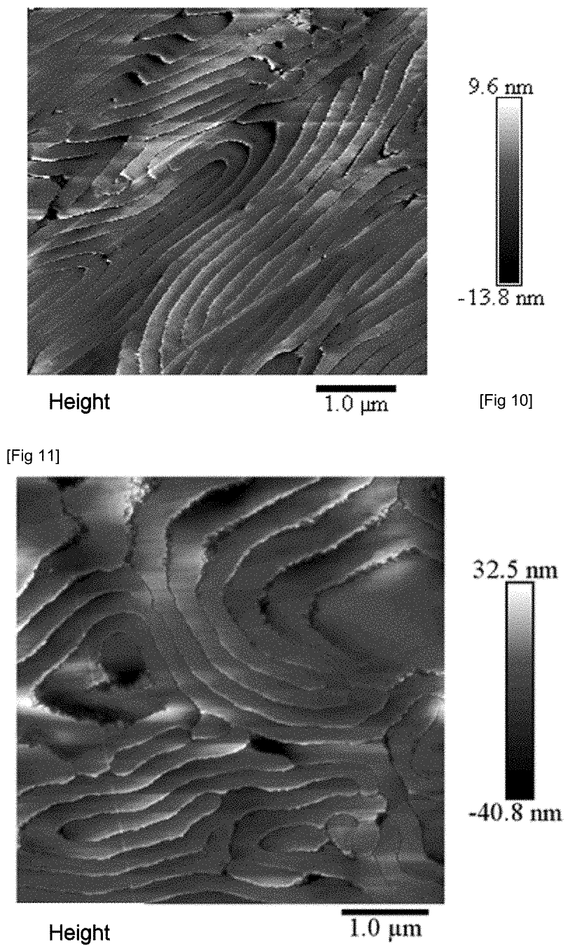

It is observed that the type of block copolymer defines the morphology (FIGS. 9, 10 and 11) and its molecular weight induces the morphology and also the interlamellar distance, which gives an additional lever for finely adjusting the morphology and associated properties.

1. A process for the bulk polymerization of a composition, said composition comprising at least one macroinitiator, at least one block copolymer and at least one monomer, said monomer being wholly or partly different from the monomer(s) present in the macroinitiator, and comprising the following stages:
mixing of at least one macroinitiator and of at least one block copolymer in a solution comprising at least one monomer,
polymerization of the solution,
recovery of the polymer obtained.

2. The process as claimed in claim 1, wherein the polymerization is of a radical type, controlled by an ATRP, RAFT, RITP or NMP route.

3. The process as claimed in claim 2, wherein the polymerization is of a radical type controlled by NMP and the macroinitiator is an alkoxyamine compound of the following formula (1): 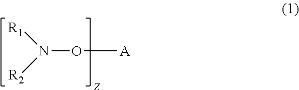
wherein:
A is a hydrocarbon group with or without heteroatoms and which can contain at least one metal entity,
R₁ is a hydrocarbon group with or without heteroatoms and which can contain at least one metal entity,
R₂ is a hydrocarbon group with or without heteroatoms and which can contain at least one metal entity,
Z is an integer between 1 and 10, limits included.

4. The process as claimed in claim 3, wherein initiation is carried out thermally.

5. The process as claimed in claim 3, wherein initiation is carried out photochemically.

6. The process as claimed in claim 3, wherein the alkoxyamine compound has a functionality of 3.

7. The process as claimed in claim 6, wherein the alkoxyamine compound comprises acrylic and/or styrene monomers.

8. The process as claimed in claim 7, wherein the alkoxyamine compound comprises styrene and butyl acrylate monomers.

9. The process as claimed in claim 7, wherein the alkoxyamine compound has a weight-average molecular weight of between 5000 and 350 000 g/mol.

10. The process as claimed in claim 7, wherein the monomers of the composition comprise methyl methacrylate.

11. The process as claimed in claim 1, wherein the block copolymer is a linear or star-branched triblock copolymer and exhibits at least one block with a glass transition temperature Tg of less than 0° C. and at least one block with a glass transition temperature Tg of greater than 20° C.

12. The process as claimed in claim 11, wherein the block copolymer is present in proportions by weight of between 0% and 90%, 0% excluded.

13. A process for 3D printing by stereolithography involving a photopolymerization reaction and at least one photoinitiator that includes the process as claimed in claim 5.

14. An article obtained by the process of claim 1.

15. A cast sheet as the article claimed in claim 14 in glazing, automobiles, motorcycles, or also ballistics.

16. A powder as the article claimed in claim 14 in laser sintering, or additives that improve mechanical properties of other polymers.

17. A rod or of a granule as the article claimed in claim 14 as an additive that improves mechanical properties of other polymers or in 3D printing.
